(19) United States
(12) Patent Application Publication
(10) Pub. No.: US 2018/0217047 A1
(43) Pub. Date: Aug. 2, 2018

(54) METHOD FOR INSPECTING A DIESEL ENGINE FILTER

(71) Applicant: EXHAUST FILTER INSPECTIONS, LLC, Winter Park, FL (US)

(72) Inventors: BRYAN CASE, MISSION VIEJA, CA (US); GREG LUKINS, SANFORD, FL (US); DAVID BUTLER, WINTER PARK, FL (US)

(21) Appl. No.: 15/878,387

(22) Filed: Jan. 23, 2018

Related U.S. Application Data
(60) Provisional application No. 62/450,664, filed on Jan. 26, 2017.

(51) Int. Cl. G01N 15/08; B01D 35/00; B01D 35/143

(52) U.S. Cl. CPC G01N 15/0826; F01N 3/021; B01D 35/143; B01D 35/005

(57) ABSTRACT

A method for inspecting a diesel particulate filter. The method comprises placing the diesel particulate filter in a test chamber, drawing air through the filter; measuring air flow through the filter, comparing a measured air flow value with a predetermined expected air flow value, determining a condition of the filter responsive to the step of comparing; and digitizing and storing the condition of the filter within a computer controller.

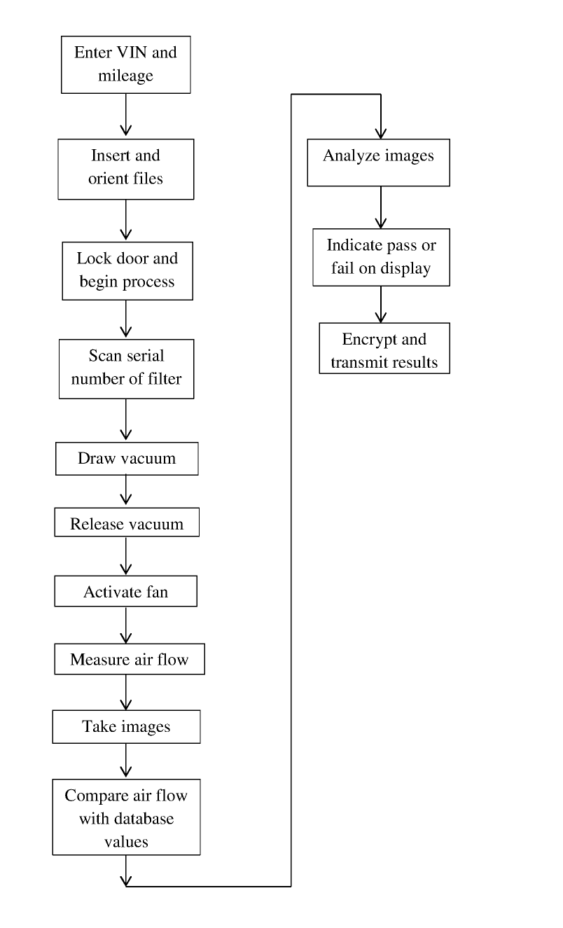

### CROSS REFERENCE TO RELATED APPLICATIONS

The present application claims priority under 35 U.S.C. 119(e) to the provisional patent application filed on Jan. 26, 2017 and assigned application No. 62/450664. This provisional patent application is incorporated in in its entirety herein.

### BACKGROUND OF THE INVENTION

Diesel particulate filters on large trucks are typically removed and cleaned as part of regular maintenance. After cleaning, the filter must be inspected to ensure it was adequately cleaned, and not damaged during the cleaning process.

It is valuable to have the results of the filter inspection filed in the vehicle maintenance records. It is also commonly necessary to have the inspection results recorded for compliance with local, state or federal emissions regulations.

When inspection is required by local, state or federal government regulation, it is critically important that the inspection process be free from human error and from variations between inspection sites and inspection personnel. But currently, filter inspection is performed manually by a human operator using non-standard methodologies. This offers ample opportunity for human error, either negligent or willful, to affect the results of the inspection. This is particularly serious when the inspection result determines whether the filter has passed or failed regulatory or government-established limits.

There is a need, then, to establish a standard process of inspecting a cleaned diesel particulate filter that eliminates human error and inspection site-to-inspection site variations.

### BRIEF DESCRIPTION OF THE DRAWINGS

The present invention can be more easily understood and the advantages and uses thereof more readily apparent when the detailed description of the present invention is read in conjunction with the figure wherein:

The FIGURE illustrates steps associated with a diesel particulate filter inspection method of the present invention.

In accordance with common practice, the various described features are not drawn to scale, but are drawn to emphasize specific features relevant to the invention. Like reference characters denote like elements throughout the figures and text.

### DETAILED DESCRIPTION OF THE INVENTION

Before describing in detail the diesel particulate filter inspection method, it should be observed that the embodiments of the present invention reside primarily in a novel and non-obvious combination of elements and method steps. So as not to obscure the disclosure with details that will be readily apparent to those skilled in the art, certain conventional elements and steps have been presented with lesser detail, while the drawings and the specification describe in greater detail other elements and steps pertinent to understanding the embodiments. The presented embodiments are not intended to define limits as to the structures, elements or methods of the inventions, but only to provide exemplary constructions. The embodiments are permissive rather than mandatory and illustrative rather than exhaustive.

The Inspection Process

The inspection process of the present invention is designed to standardize the inspections of a cleaned filter, remove many of the possible opportunities for human error to affect the outcome of the inspection, determine and record the inspection results by a machine, and deliver the inspection results to the required destination using a secure electronic communications technique.

Automating the entire process from the inspection to filing the result is advantageous for several reasons: (i) it reduces the labor cost of inspection, recording and filing the results, (ii) it reduces the possible sources of error, (iii) it allows the process to be certified and inspected by regulatory bodies, and (iv) it reduces the amount of time required for vehicle operators to obtain the necessary operational permits after the filter has been cleaned.

The inspection process uses an inspection machine designed to test a filter in an automatic and repeatable way. The machine should include safeguards to prevent tampering with or influencing the inspection process and results. Such a machine is described in patent application Ser. No. ______, filed on Jan. 23, 2018 and entitled Diesel Particulate Filter Inspection Machine (Attorney Docket Number 15224-001), which is incorporated herein in its entirety.

The machine comprises a locking test chamber, a sensor for reading the unique serial number of the filter, an image sensor for capturing an image of the filter, a light source on the opposite side of the filter from the image sensor, a component for sealing one end of the filter, a pump for evacuating the air inside the filter, a pressure sensor for measuring air pressure, a flow sensor for measuring air flow, a fan for moving air through the filter, a control panel, and a computer controller for operating the inspection machine, determining the inspection result, and transmitting the results securely across a computer network to another computer system. In one embodiment, the transmission is made according to a predefined application programming interface (API).

With reference to the machine's user interface, the process begins when the machine operator enters the VIN of the vehicle from which the filter was removed and the mileage of the vehicle. The operator then inserts the filter into the machine, orienting the filter so that the serial number on the filter can be scanned by a sensor or reader.

When the operator locks the door on the inspection machine and starts the automated inspection process (for example, by pressing a button or touching an icon on a display associated with the computer controller), a plate moves downwardly to seal the top of the filter and the sensor or reader scans the serial number on the filter.

With the sealing plate properly positioned, a vacuum pump on the machine is activated to reduce air pressure inside the filter. The air pressure is monitored for leaks in the machine. If the filter is properly sealed and positioned inside the machine, and no attempts have been made to influence the flow of air around the filter, the pressure will not change once the vacuum is established. This check ensures the filter is properly positioned in the inspection machine and the process continues. If the pressure check fails, an error message is displayed on a user interface or the display and the process terminated.

Next, the machine turns on the fan and measures the airflow through the filter. Simultaneously, a light source is turned on and the image sensor captures images of the filter.

The images are processed by the computer controller to identify areas in the filter that are clogged or cracked. An excessive number of clogged areas or the presence of cracks are valid reasons for replacing the filter.

The computer controller also compares the measured airflow to a database of predetermined air flow values to determine whether the measured airflow value indicates a passed or failed filter. The computer controller also reviews the image processing results. The measured air flow value relative to the database values and optionally the image processing results determine if the filter passes the inspection criteria.

The outcome is displayed on the user interface. The displayed outcome is primarily a pass/fail result, but one embodiment also includes a reason for any failure, e.g., insufficient airflow, blockage detected in the air flow path, or a crack detected.

The computer controller includes the following information into a single data file for electronic transfer: the serial number of the inspection machine, the digital image file, the airflow measurement value, the serial number of the filter, the VIN for the vehicle from which the filter was removed, and the vehicle mileage.

In order to ensure a secure electronic transmission, hashing and symmetric-key cryptography techniques (such as pretty-good privacy, PGP) must be used.

In one embodiment a checksum value for the data file is calculated by the computer controller using a cryptographic hash calculation. The checksum is also digitally signed using public key cryptographic keys assigned to the computer controller during manufacturing. The data file is then encrypted using the same cryptographic keys. Such techniques are fairly standard and known by those skilled in the art for transmitting information from an Internet of Things (IoT) device to a remote computer. This process simply ensures that the information arriving at a server: (a) originated from the correct filter inspection IoT device and not from an impersonator, and (b) the data hasn't been tampered with while in transit along the communications path.

The computer controller then establishes a connection to the Internet and sends the digitally signed and encrypted data file to a remotely connected processing computer.

The receiving processing computer checks the digital signature of the received checksum value using private cryptographic keys. If the signature is valid, the data file is decrypted and its checksum value calculated. If the checksum values match, the processing computer opens the data file and decompresses the contents. The processing computer also sends an acknowledgement of successful receipt back to the computer controller over the Internet.

If the signature is invalid or the checksum is invalid, the compressed data is discarded and the processing computer sends a message to the computer controller that the received data was invalid. The computer controller will continue to resend the compressed data until it receives an acknowledgement from the processing computer that the data is correct.

The processing computer stores the decompressed files into a locally- or remotely-connected database.

Individual regulatory bodies will have their own unique data requirements and application program interfaces (APIs). The processing computer is programmed with the API for each individual regulatory body. The relevant data and security methods required for communicating with the regulatory agency's computer system will be used by the processing computer. As the regulatory body requests information, the processing computer electronically transmits information to the appropriate destination computer according the appropriate API.

The processing computer is capable of accepting data files from multiple inspection machines, and reporting data to multiple regulatory bodies and processing computers.

The FIGURE depicts the steps associated with the inspection process of the invention, each of which is discussed above in detail.

What is claimed is:

1. A method for inspecting a diesel particulate filter, the method comprising:
placing the diesel particulate filter in a test chamber;
drawing air through the filter;
measuring air flow through the filter;
comparing a measured air flow value with a predetermined expected air flow value;
determining a condition of the filter responsive to the step of comparing; and
digitizing and storing the condition of the filter within a computer controller.

2. The method of claim 1 further comprising displaying the condition of the filter on a display.

3. The method of claim 1 wherein the condition comprises a passed diesel particulate filter or a failed diesel particulate filter.

4. The method of claim 1 further comprising creating filter images and determining from an image whether a crack is present in a structure of the filter.

5. The method of claim 1 further comprising creating filter images and determining from an image whether a clog is present within the filter.

6. The method of claim 1 further comprising, prior to the step of drawing, closing a top surface of the filter and creating a vacuum within the test chamber, to ensure the diesel particulate filter is properly placed within the test chamber.

7. The method of claim 1 further comprising a step of measuring a pressure outside the testing chamber, an outside pressure measured value for use in a step of measuring air flow through the filter.

8. The method of claim 7 the outside pressure for use as a reference pressure for a manometer conducting a step of measuring air flow through the filter.

9. The method of claim 1 identifying the diesel particulate filter by reading identification information associated with the filter.

10. The method of claim 1 further comprising creating a digital data file comprising a pass or fail determination for the filter and identification information of the filter.

11. The method of claim 10 further including one or more of an image file comprising photographs of the filter, a measured airflow, identification information of the inspection machine, identification information of a vehicle from which the filter was removed, and a vehicle mileage when the filter was removed.

12. The method of claim 10 further comprising transmitting the digital data file to a remote site.

13. The method of claim 12 wherein the remote site comprises a site of a regulatory agency, an electronic data storage location, or a site of a vehicle owner.

14. The method of claim 12 further comprising encrypting the digital data file prior to a step of transmitting.

15. The method of claim 12 further comprising affixing a digital signature to the digital data file.

16. The method of claim 1 further comprising measuring an outside air pressure, wherein a step of measuring air flow is responsive the outside air pressure.

17. The method of claim 1 wherein the step of placing the diesel particulate filter comprises placing the diesel particulate filter on a support ring having a central opening, the method further comprising determining a size of the central opening and comparing the size of the central opening with a size of an air flow path through the filter.

18. The method of claim 17 further comprising reading a tag affixed to the support ring, the tag carrying information related to a size of the central opening, and comparing a size of the central opening with a size of an air flow path through the filter.

19. The method of claim 1 further comprising creating a vacuum within a region of the test chamber prior to a step of drawing air through the filter.

20. The method of claim 1 further comprising reading information carried on the diesel particulate filter, the information comprising a number uniquely identifying the diesel particulate filter and associating results of the diesel particulate inspection with the number.
